(19) United States
(12) Patent Application Publication
(10) Pub. No.: US 2021/0406473 A1
(43) Pub. Date: Dec. 30, 2021

(54) SYSTEM AND METHOD FOR BUILDING CHATBOT PROVIDING INTELLIGENT CONVERSATIONAL SERVICE

(71) Applicant: ACRYL INC., Seoul (KR)

(72) Inventors: Jisung Park, Seoul (KR); Insik Jung, Seoul (KR); Hyunho Lee, Seoul (KR); Wei Jin Park, Seoul (KR)

(21) Appl. No.: 17/359,004

(22) Filed: Jun. 25, 2021

(30) Foreign Application Priority Data
Jun. 25, 2020 (KR) 10-2020-0077495

(51) Int. Cl. G06F 40/295; H04L 12/58

(52) U.S. Cl. CPC G06F 40/295; H04L 51/02

(57) ABSTRACT

A system for building a chatbot providing an intelligent conversational service is proposed. The system includes: a chatbot-builder conversational interface configured to receive an input of an utterance of a user or a sentence written by the user; an NLU engine configured to analyze the utterance of the user, or the sentence, phrase, and word written by the user to identify utterance intention of the user and a main key keyword used in the utterance intention; a chatbot-building-component recommendation engine configured to analyze the utterance of the user by the NLU engine, analyze an existing scenario and a user input scenario, automatically extract a knowledge base element, and recommend at least one of a service-specific scenario, a chatbot component, and a GUI node structure to the user; and a scenario DB configured to store a service-specific scenario and a customized scenario made by an actual service provider.

### CROSS REFERENCE TO RELATED APPLICATION

The present application claims priority to Korean Patent Application No. 10-2020-0077495, filed Jun. 25, 2020, the entire contents of which is incorporated herein for all purposes by this reference.

### BACKGROUND OF THE INVENTION

### Field of the Invention

The present invention relates to a system for building a chatbot providing an intelligent conversational service and, more particularly, to a system and method for building a chatbot providing an intelligent conversational service, wherein the system allows a user to build a chatbot that provides the intelligent conversational service in a format of a chat, in which the chatbot answers questions of the user on the basis of a GUI (graphical user interface)-based conversational chatbot builder.

### Description of the Related Art

Nowadays, along with the development of information and communication technologies including computers, artificial intelligence (AI) technology is also developing gradually, and is currently applied to various fields. One of the technologies to which such artificial intelligence (AI) is applied is a chatbot.

A conventional chatbot refers to a conversational messenger in which when a person enters a question as if the person were chatting in a corporate messenger, artificial intelligence (AI) provides an answer on the basis of big data analysis, and the like, while communicating with the person in everyday language. Since IT companies are able to analyze usage patterns of business smartphones or PCs while providing corporate messenger services or improve natural language processing capabilities by collecting big data such as a language primarily used in business, the competition among IT companies is gradually intensifying. Since a corporate messenger that adopted such chatbot functions may check and process information in a chat window without running a separate app, there is an advantage that the corporate messenger may be used as a platform in which various functions are integrated by interconnection.

Recently, the use of chatbots is not limited to corporate messengers, but have been widely used throughout the IT industry. For example, in a case of an administrator in charge of operating an Internet shopping mall or a homepage, the administrator should allocate a certain amount of time to respond to user's (i.e., customer's) questions, or provide a FAQ page to answer to frequently asked questions. However, with only these methods, users (i.e., customers) are inconvenienced because the users have to wait until a direct conversation with the administrator is established in order to find what the users desire to know, or the users have to search the FAQ page by themselves.

Meanwhile, Korean Patent No. 10-1944353 discloses “METHOD AND APPARATUS FOR PROVIDING CHATBOT BUILDER USER INTERFACE”. In the method for providing a user interface of a chatbot builder according to the disclosure, the method includes: providing a UI (User Interface) of a chatbot builder for building a chatbot; providing parameter information, which is attribute information about each word included in at least one sentence when receiving the at least one sentence from a builder terminal; and performing grouping on two or more pieces of parameter information selected by a builder terminal, wherein the chatbot built by the builder terminal is driven by a user terminal accessing a chatbot service server, and the chatbot performs a preset command with reference to the extracted parameter information when one or more pieces of parameter information among the grouped two or more pieces of parameter information are extracted from a sentence of a chatting message input from the user terminal.

As described above, in the case of the above document, when providing the user interface of the chatbot builder for building a chatbot, a builder may directly select and group a plurality of parameters, so that each parameter to which an entity extracted from a user's utterance sentence input into the corresponding chatbot belongs may be searched for in a group unit, thereby having an advantage that the chatbot may quickly identify and execute a command appropriate to each parameter. However, the related document contains a problem that a processing operation becomes complicated as the builder terminal performs grouping on the selected two or more pieces of parameter information.

### SUMMARY OF THE INVENTION

The present invention has been devised in comprehensive consideration of the above matters, and an objective of the present invention is to provide a system and method for building a chatbot providing an intelligent conversational service, wherein on the basis of a graphical user interface (GUI)-based conversational chatbot builder, the system and method enables building of the chatbot that provides an intelligent conversational service in a chat format in which the chatbot answers user questions.

In order to achieve the above objective, according to the present invention, a system for building a chatbot providing an intelligent conversational service includes: a chatbot-builder conversational interface configured to receive an input of an utterance of a user or a sentence written by the user; an NLU (Natural Language Understanding) engine configured to analyze the utterance of the user, or the sentence, a phrase, and a word written by the user to identify utterance intention of the user and a main key keyword used in the utterance intention; a chatbot-building-component recommendation engine configured to analyze the utterance of the user, by the NLU engine, through named-entity recognition, utterance intention recognition, a conversation flow analysis, and text sensibility recognition for the utterance of the user, analyze an existing scenario and a user input scenario in a scenario database (DB) according to the user input scenario, automatically extract a knowledge base element, and recommend at least one of a service-specific scenario, a chatbot component, and a GUI node structure to the user through the chatbot-builder conversational interface, thereby self-recommending an intelligent service appropriate for each domain; and the scenario database (DB) configured to store the service-specific scenario as a preset made in advance for the existing scenario and a customized scenario made by an actual service provider using the service-specific scenario.

Here, the chatbot component may include an intent, which is the utterance intention of a speaker when spoken in natural language; and an entity, which is an element that is included in the sentence.

In addition, the NLU engine may be configured in a form of a single language model that performs the named-entity recognition, the text sensibility recognition, the utterance intention recognition, and the conversation flow analysis.

In addition, the user input scenario may include at least one of a request, a question, and an assertion.

In addition, the scenario DB may include: a service-specific scenario DB in which the service-specific scenario as the preset made in advance for the existing scenario is stored; and a service provider scenario DB in which the customized scenario made by the actual service provider using the service-specific scenario is stored.

In addition, in order to achieve the above objective, according to the present invention, there is provided a method for building a chatbot providing an intelligent conversational service, the method based on a system for building a chatbot providing an intelligent conversational service, the system including a chatbot-builder conversational interface, an NLU engine, a chatbot-building-component recommendation engine, and a scenario database (DB), the method including: a) receiving, by the chatbot-builder conversational interface, an input of an utterance of a user or a sentence written by the user; b) analyzing the utterance of the user, by the chatbot-building-component recommendation engine using the NLU engine, through named-entity recognition, utterance intention recognition, a conversation flow analysis, and text sensibility recognition for the utterance of the user; c) automatically extracting, by the chatbot-building-component recommendation engine, a knowledge base element by analyzing an existing scenario and a user input scenario in the scenario database (DB) according to the user input scenario; and d) building the chatbot, by the chatbot-building-component recommendation engine, that self-recommends an intelligent service appropriate for each domain by recommending at least one of a service-specific scenario, a chatbot component, and a GUI node structure to the user through the chatbot-builder conversational interface.

Here, the chatbot component may include: an intent, which is utterance intention of a speaker when spoken in natural language; and an entity, which is an element that is included in the sentence.

In addition, the NLU engine may be configured in a form of a single language model that performs the named-entity recognition, the text sensibility recognition, the utterance intention recognition, and the conversation flow analysis.

In addition, the user input scenario may include at least one of a request, a question, and an assertion.

In addition, the scenario DB may include: a service-specific scenario DB in which the service-specific scenario as a preset made in advance for the existing scenario is stored; and a service provider scenario DB in which a customized scenario made by an actual service provider using the service-specific scenario is stored.

According to the present invention as described above, there is an advantage that a chatbot that provides an intelligent conversational service in a chat format in which the chatbot answers user questions may be built on the basis of the graphical user interface (GUI)-based conversational chatbot builder.

### BRIEF DESCRIPTION OF THE DRAWINGS

FIG. 1 is a view schematically showing a configuration of a system for building a chatbot providing an intelligent conversational service according to the present invention.

FIG. 2 is a flowchart showing an execution process of a method for building a chatbot providing an intelligent conversational service according to the present invention.

FIG. 3 is a view showing an overview of named-entity recognition by text analysis intelligence applied to a chatbot-building-component recommendation engine of the system for building a chatbot providing an intelligent conversational service according to the present invention.

FIG. 4 is a view showing an overview of text sensibility recognition by sensibility intelligence applied to the chatbot-building-component recommendation engine of the system for building a chatbot providing an intelligent conversational service according to the present invention.

FIG. 5 is a view showing an overview of empathetic question-response matching by conversational intelligence applied to the chatbot-building-component recommendation engine of the system for building a chatbot providing an intelligent conversational service according to the present invention.

FIG. 6 is a view showing an overview of providing a node structure in the system and method for building a chatbot providing an intelligent conversational service according to the present invention.

FIG. 7A is a view showing a first part of an overview of providing a conversational structure in the system and method for building a chatbot providing an intelligent conversational service according to the present invention.

FIG. 7B is a view showing a second part of the overview of FIG. 7A.

### DETAILED DESCRIPTION OF THE INVENTION

The terms or words used in this description and claims are not to be construed as being limited to their ordinary or dictionary meanings, and should be interpreted as meanings and concepts corresponding to the technical spirit of the present invention based on the principle that inventors may properly define the concept of a term in order to best describe their invention.

Throughout the description of the present invention, when a part is said to “include” or “comprise” a certain component, it means that it may further include or comprise other components, except to exclude other components unless the context clearly indicates otherwise. In addition, the terms “˜ part”, “˜ unit”, “module”, and the like mean a unit for processing at least one function or operation and may be implemented by a combination of hardware and/or software.

Hereinafter, an exemplary embodiment of the present invention will be described in detail with reference to the accompanying drawings.

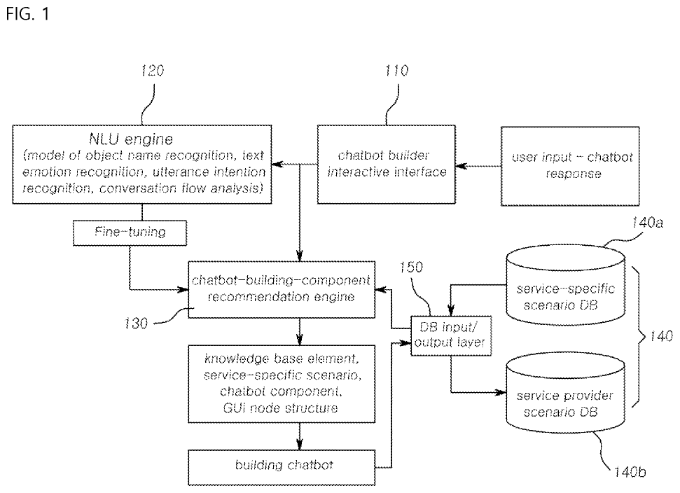

FIG. 1 is a view schematically showing a configuration of a system for building a chatbot providing an intelligent conversational service according to the exemplary embodiment of the present invention.

Referring to FIG. 1, the system 100 for building a chatbot providing an intelligent conversational service according to the present invention is configured to include: a chatbot-builder conversational interface 110, a NLU (natural language understanding) engine 120, a chatbot-building-component recommendation engine 130, and a scenario database (DB) 140. Here, each of these components may be implemented by hardware or software or a combination of hardware and software.

The chatbot-builder conversational interface 110 receives an utterance of a user or a sentence written by the user.

The NLU engine 120 analyzes the utterance of the user, or the sentence, phrase, or word written by the user so as to identify the utterance intention of the user and main keywords used in the utterance intention. Such an NLU engine 120 may be configured in a form of a single language model that performs named-entity recognition, text sensibility recognition, utterance intention recognition, a conversation flow analysis, and the like.

The chatbot-building-component recommendation engine 130 performs steps, including: analyzing an utterance of a user, by the NLU engine 120, through named-entity recognition, utterance intention recognition, a conversation flow analysis, and text sensibility recognition; automatically extracting a knowledge base element, according to a user input scenario, by analyzing an existing scenario and the user input scenario in a scenario database (DB); and recommending an intelligent service suitable for each domain by recommending at least one of a service-specific scenario, a chatbot component, and a GUI node structure to a user through the chatbot-builder conversational interface 110. Here, the user input scenario may include at least one of a request, a question, and an assertion. The chatbot component may include: an intent, which is utterance intention of a speaker when spoken in natural language (i.e., language used by humans to communicate); and an entity, which is an element that is included in the sentence.

The scenario database (DB) 140 stores: a service-specific scenario as a preset made in advance for the existing scenario; and a customized scenario made by an actual service provider using the service-specific scenario. Such a scenario database (DB) 140 may be configured to include: a service-specific scenario DB 140a in which the service-specific scenario as the preset made in advance for the existing scenario is stored; and a service provider scenario DB 140b in which the customized scenario made by the actual service provider using the service-specific scenario is stored.

Here, the system 100 having the above configuration for building a chatbot providing an intelligent conversational service according to the present invention, may further include: a DB input/output layer 150, as a communication interface, in which a service-specific scenario recommended by the chatbot-building-component recommendation engine 130 is received and provided to a chatbot building process, and a final service provider scenario written by a user through the chatbot building process is provided to the service provider scenario DB 140b.

Hereinafter, a method for building a chatbot providing an intelligent conversational service based on the system 100 for building a chatbot providing an intelligent conversational service according to the present invention, the system having the above configuration, will be briefly described.

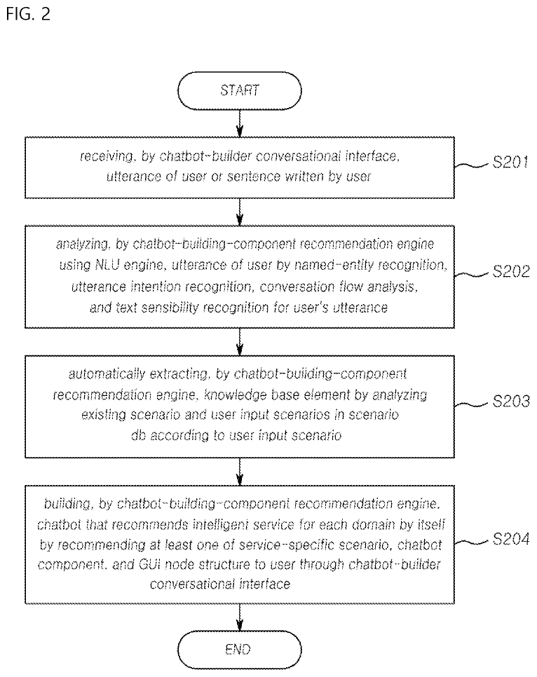

FIG. 2 is a flowchart showing an execution process of the method for building a chatbot providing an intelligent conversational service according to the exemplary embodiment of the present invention.

Referring to FIG. 2, the method for building a chatbot providing an intelligent conversational service according to the present invention is an above-described chatbot building method based on the system 100 for building a chatbot providing an intelligent conversational service, including: a chatbot-builder conversational interface 110; an NLU engine 120; a chatbot-building-component recommendation engine 130; and a scenario database (DB) 140. First, in step S201, the chatbot-builder conversational interface 110 receives an utterance of a user or a sentence written by the user.

Thereafter, in step S202, the chatbot-building-component recommendation engine 130 uses the NLU engine 120 to analyze the utterance of the user through named-entity recognition, utterance intention recognition, conversation flow recognition, and text sensibility recognition with respect to the utterance of the user. In this case, the NLU engine 120 may be configured in the form of a single language model that performs named-entity recognition, text sensibility recognition, utterance intention recognition, a conversation flow analysis, and the like.

In addition, in step S203, by the chatbot-building-component recommendation engine 130, a knowledge base element is automatically extracted through analyzing an existing scenario and a user input scenario in the scenario database (DB) 140 according to the user input scenario. Here, the user input scenario may include at least one of a request, a question, and an assertion. In addition, the knowledge base element may be referred to as auxiliary base knowledge for each of the fields to which the present invention is applied (e.g., a hospital, a cafe, a logistics center, etc.), and for example, the knowledge base element may be a generic term for beverage, order text, intent, entity, and the like when a user envisions a cafe ordering scenario. In addition, the scenario DB 140, as shown in FIG. 1, may be configured to include: a service-specific scenario DB 140a in which a service-specific scenario as a preset for an existing scenario is stored; and a service provider scenario DB 140b in which a customized scenario made by an actual service provider using the service-specific scenario is stored.

Thereafter, in step S204, at least one of a service-specific scenario, a chatbot component, and a GUI node structure is recommended to the user through the chatbot-builder conversational interface 110, so as to build a chatbot that recommends an intelligent service appropriate for each domain (e.g., a field to which the present invention is applied, such as a hospital, a cafe, a logistics center, and the like). In this case, the chatbot component may include: an intent, which is utterance intention of a speaker when spoken in natural language (i.e., language used by humans to communicate); and an entity, which is an element that is included in the sentence.

Here, an explanation in relation to the above series of processes will be further described. For example, when a user inputs topics of a chatbot builder to be built, the chatbot-building-component recommendation engine 130 compares similarity between the topics through a TCR (Topic Cluster Recognition) engine, and imports the preset made in advance for the existing similar scenario from the service-specific scenario DB 140a. In addition, in detailed parts different from the existing preset, a sentence input by the user is analyzed as a “sentence to graph” model, domain nouns are extracted, and related chatbot components and scenarios are presented to the user.

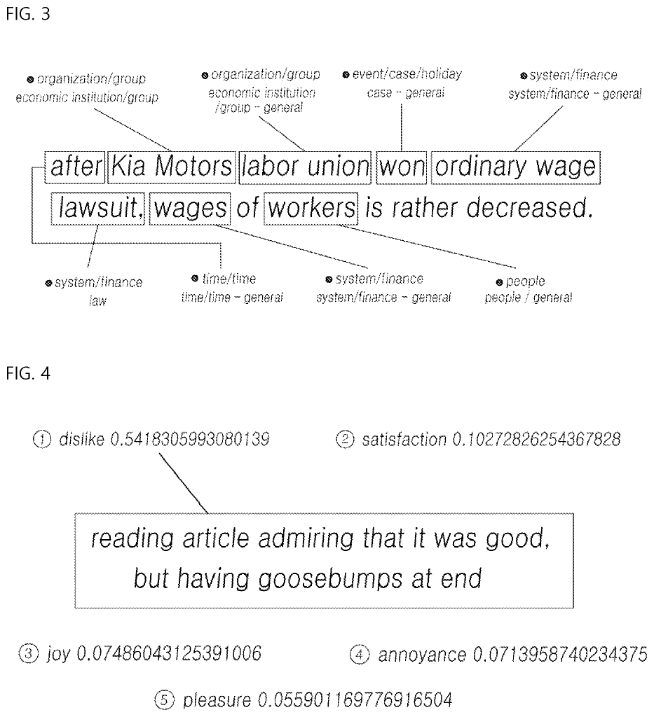

Meanwhile, FIG. 3 is a view showing an overview of named-entity recognition by text analysis intelligence applied to a chatbot-building-component recommendation engine of the system for building a chatbot providing an intelligent conversational service according to the present invention.

Referring to FIG. 3, the named-entity recognition is text analysis intelligence, and is a deep learning module that recognizes (i.e., about 129 types of entity names may be recognized) entity names (e.g., Kia Motors, union, ordinary wage, lawsuit, win a suit, worker, wage, etc.) in a given text independently of a morpheme analyzer. As described above, in the present invention, by applying a machine learning algorithm independent of morpheme analysis information, it is possible to increase performance of the named-entity recognition for sentences having severe grammar destruction.

FIG. 4 is a view showing an overview of text sensibility recognition by sensibility intelligence applied to the chatbot-building-component recommendation engine of the system for building a chatbot providing an intelligent conversational service according to the present invention.

Referring to FIG. 4, the text sensibility recognition is the sensibility intelligence, and is a deep learning module that recognizes 34 kinds of sensibility in a given text independently of the morpheme analyzer. The sensibility intelligence may recognize positive/negative/neutral sensibility valence, representative sensibility of 8 types (excluding neutral sensibility valence), and detailed sensibility of 34 types (excluding neutral sensibility valence).

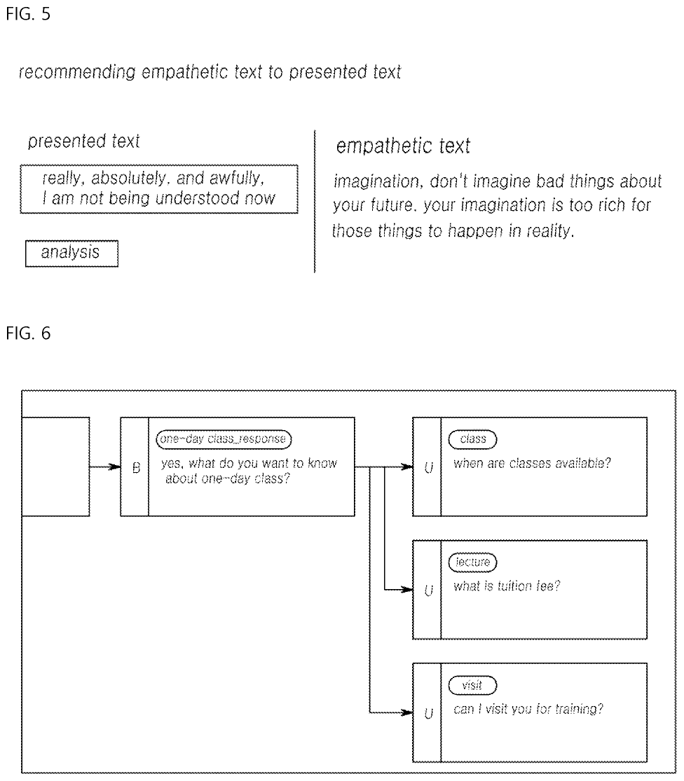

FIG. 5 is a view showing an overview of empathetic question-response matching by conversational intelligence applied to the chatbot-building-component recommendation engine of the system for building a chatbot providing an intelligent conversational service according to the present invention.

Referring to FIG. 5, the empathetic question-response matching is conversational intelligence, and is a deep learning module that performs analysis on a given text and matches the given text to a text having the highest level of empathy. Such conversational intelligence has a function of learning a corpus about a worries text and an empathy text in pair and providing an appropriate empathy text when a worries text is input. Such conversational intelligence may be implemented by learning a vector conversion pattern between text pairs (worries-empathy) generated in each independent vector space by way of using a function of vectorizing documents.

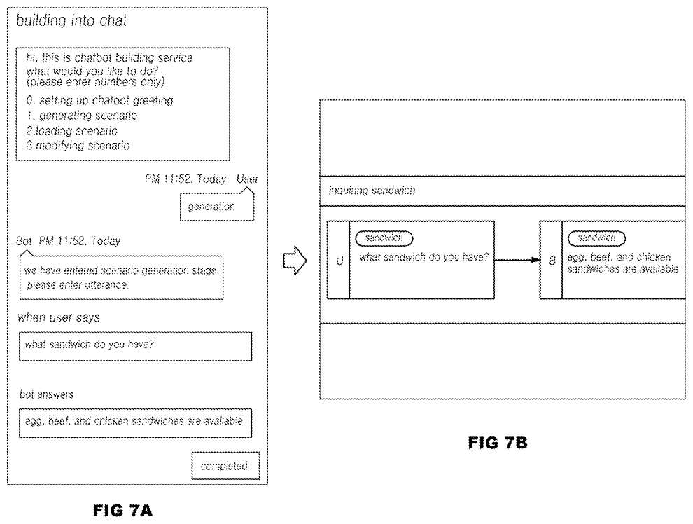

FIG. 6 and FIGS. 7A and 7B are views respectively showing overviews of providing a node structure and a conversational structure in the system and method for building a chatbot providing an intelligent conversational service according to the present invention.

Referring to FIG. 6, FIG. 6 shows the providing of the node structure, and in the system of the present invention, a user-friendly feeling (i.e., function) is provided by visualizing a conversation flow in the node structure. With such a node structure, a user may easily understand a connection from a chatbot's first greeting conversation to the last conversation, as well as how the conversations are connected to other conversations. In addition, the user may directly connect to a desired conversation with a click of a mouse to complete the conversation flow, and when correction is required, the existing connected conversation may be disconnected and a new conversation may be connected thereto to modify and add the conversation flow.

FIGS. 7A and 7B show the providing of the conversational structure, where FIG. 7A shows inputting of a question and an answer, and FIG. 7B shows generating of a question-answer node structure.

The conversational structure is a method in which a user builds a chatbot through a conversation. This method utilizes a high-performance natural language understanding engine to recognize questions of a user and automatically identify intent of the user. In addition, a chatbot user's questions and the chatbot's answers to the questions are input as a chat, and the input question and answer set is visualized in the node structure as shown in (B) to help the user understand. Since the present invention is the method for building a chatbot through a chat, even a user with low understanding of the chatbot may generate a desired conversation flow with a simple user explanation.

As described above, the system and method for building a chatbot providing an intelligent conversational service according to the present invention recommends chatbot components necessary for building the chatbot according to a chatbot scenario presented by a user, so there is an advantage that people who have no experience in building a chatbot may easily generate the chatbot as well.

In addition, there is an advantage of enabling the building of a chatbot that provides an intelligent conversational service in a chat format in which the chatbot answers user's questions on the basis of a graphical user interface (GUI)-based conversational chatbot builder.

In addition, there is an advantage that the user's questions and the chatbot's answers are visualized and displayed in the node structure so as to enable the user to understand the user's questions and chatbot's answers.

In addition, there is an advantage that a domain is automatically structured, and then a strong recommendation-based builder may be provided for creating a chatbot builder.

As above, the present invention has been described in detail through the preferred exemplary embodiments, but the present invention is not limited thereto, and it is apparent to those skilled in the art that various changes and applications may be made within the scope of the present invention without departing from the technical spirit of the present invention. Accordingly, the true protection scope of the present invention should be construed by the following claims, and all technical ideas within the scope equivalent thereto should be construed as being included in the scope of the present invention.

What is claimed is:

1. A system for building a chatbot providing an intelligent conversational service, the system comprising:
a chatbot-builder conversational interface configured to receive an input of an utterance of a user or a sentence written by the user;
an NLU (Natural Language Understanding) engine configured to analyze the utterance of the user, or the sentence, a phrase, and a word written by the user to identify utterance intention of the user and a main key keyword used in the utterance intention;
a chatbot-building-component recommendation engine configured to analyze the utterance of the user, by the NLU engine, through named-entity recognition, utterance intention recognition, a conversation flow analysis, and text sensibility recognition for the utterance of the user, analyze an existing scenario and a user input scenario in a scenario database (DB) according to the user input scenario, automatically extract a knowledge base element, and recommend at least one of a service-specific scenario, a chatbot component, and a GUI node structure to the user through the chatbot-builder conversational interface, thereby self-recommending an intelligent service appropriate for each domain; and
the scenario database (DB) configured to store the service-specific scenario as a preset made in advance for the existing scenario and a customized scenario made by an actual service provider using the service-specific scenario.

2. The system of claim 1, wherein the chatbot component comprises:
an intent, which is the utterance intention of a speaker when spoken in natural language; and
an entity, which is an element that is included in the sentence.

3. The system of claim 1, wherein the NLU engine is configured in a form of a single language model that performs the named-entity recognition, the text sensibility recognition, the utterance intention recognition, and the conversation flow analysis.

4. The system of claim 1, wherein the user input scenario comprises at least one of a request, a question, and an assertion.

5. The system of claim 1, wherein the scenario DB comprises:
a service-specific scenario DB in which the service-specific scenario as the preset made in advance for the existing scenario is stored; and
a service provider scenario DB in which the customized scenario made by the actual service provider using the service-specific scenario is stored.

6. A method for building a chatbot providing an intelligent conversational service, the method based on a system for building a chatbot providing an intelligent conversational service, the system comprising a chatbot-builder conversational interface, an NLU engine, a chatbot-building-component recommendation engine, and a scenario database (DB), the method comprising:
a) receiving, by the chatbot-builder conversational interface, an input of an utterance of a user or a sentence written by the user;
b) analyzing the utterance of the user, by the chatbot-building-component recommendation engine using the NLU engine, through named-entity recognition, utterance intention recognition, a conversation flow analysis, and text sensibility recognition for the utterance of the user;
c) automatically extracting, by the chatbot-building-component recommendation engine, a knowledge base element by analyzing an existing scenario and a user input scenario in the scenario database (DB) according to the user input scenario; and
d) building the chatbot, by the chatbot-building-component recommendation engine, that self-recommends an intelligent service appropriate for each domain by recommending at least one of a service-specific scenario, a chatbot component, and a GUI node structure to the user through the chatbot-builder conversational interface.

7. The method of claim 6, wherein the NLU engine is configured in a form of a single language model that performs the named-entity recognition, the text sensibility recognition, the utterance intention recognition, and the conversation flow analysis.

8. The method of claim 6, wherein in step c), the user input scenario comprises at least one of a request, a question, and an assertion.

9. The method of claim 6, wherein in step d), the chatbot component comprises: an intent, which is utterance intention of a speaker when spoken in natural language; and
an entity, which is an element that is included in the sentence.

10. The method of claim 6, wherein the scenario DB comprises:
a service-specific scenario DB in which the service-specific scenario as a preset made in advance for the existing scenario is stored; and
a service provider scenario DB in which a customized scenario made by an actual service provider using the service-specific scenario is stored.
